(19) United States
(12) Patent Application Publication
(10) Pub. No.: US 2008/0168716 A1
(43) Pub. Date: Jul. 17, 2008

(54) Gasket Assembly for a Pet Door Flap

(75) Inventor: William S. Groh, Knoxville, TN (US)

Correspondence Address: PITTS AND BRITTIAN P C, P O BOX 51295, KNOXVILLE, TN, 37950-1295, US

(73) Assignee: Radio Systems Corporation, Knoxville, TN (US)

(21) Appl. No.: 11/622,459

(22) Filed: Jan. 11, 2007

Related U.S. Application Data
(63) Continuation of application No. 10/892,708, filed on Jul. 16, 2004, now abandoned.

(51) Int. Cl. E06B 7/16

(52) U.S. Cl. 49/475.1

(57) ABSTRACT

A pet door gasket assembly adapted to provide a strong thermal, chemical, and mechanical bond between the gasket and a rigid pet door flap adapted to be mounted within an opening in a frame in a manner permitting a pet to have unattended ingress and egress through the opening. The gasket assembly incorporates a flexible, resilient, and permanently lubricated polymeric material chemically and mechanically bonded to the perimetrical portion of a rigid pet door flap. The gasket is formed of a moldable resilient and flexible polymeric material encircles the perimetrical edge of the flap and extends radially inwardly and along the first and second faces of, the annular perimetrical portion of the central portion of the flap, about end portions of pins which project from the opposite faces of the annular portion of the flap, and terminates at flanges defined on the annular portion of the perimetrical portion of the flap.

### CROSS-REFERENCE TO RELATED APPLICATIONS

This application is a continuation of prior application Ser. No. 07/892,708, filed Jul. 16, 2004.

### STATEMENT REGARDING FEDERALLY SPONSORED RESEARCH OR DEVELOPMENT

Not Applicable.

### BACKGROUND OF THE INVENTION

1. Field of Invention

The invention relates to a gasket assembly for a pet door. More specifically, this invention relates to a molded gasket assembly adapted to be securely affixed to a pet door flap.

2. Description of the Related Art

Conventional pet doors utilizing a rigid flap generally have a gasket or weather strip to seal the area between the flap and the pet door frame. Common materials used for the weather strip include a rubber gasket or fibrous flock material. Such weather-stripping materials are secured to the flap in a channel around the edge of the flap and held in place by friction, i.e., the gasket is “pinched” in the channel. Such a construction relies on a purely mechanical bond. In some cases, either or both of the weather strip and the channel include a shoulder to further resist the removal of the weather strip. Such weather-stripping options require additional labor to install as they require that separate pieces be put together. However, such weather strips are still subject to falling off, being torn off, and the channel loaded with or the gasket covered with foreign objects, e.g., dirt and mud.

FIG. 3 illustrates a prior-art weather stripping configuration, such as is found in pet doors. In the illustrated embodiment, the pet door flap 300 has a radial extension 302 about the perimeter thereof comprising a polymeric material 304 affixed frictionally to the radial extension 302. However, a weather-stripping material 304 secured to only the radial extension 302 of the pet door flap 300 has only minimal resistance to detachment of the weather-stripping material 304 during the useful life of the pet door flap 300. During the life of a pet door, the repeated stresses and the extreme environmental factors that are encountered degrade the bond between the pet door flap 300 and the weather-stripping material 304, which allows the weather-stripping material 304 to fall away from the pet door flap 300.

Accordingly, there is a need for a pet door gasket that is securely bonded to the pet door flap with sufficient structure to prevent removal even after years of continuous operation in extreme environmental conditions.

### BRIEF SUMMARY OF THE INVENTION

A pet door gasket assembly adapted to provide a strong thermal, chemical, and mechanical bond between the gasket and the pet door flap is shown and described. The gasket assembly incorporates a flexible, resilient, and permanently lubricated polymeric material chemically and thermally bonded to a rigid pet door flap. Further, the gasket is molded around series of pins extending from the faces of the rigid flap to provide a mechanical bond with the pet door flap. The lubricated gasket material resists wear and tear and offers reduced friction to allow for unhindered movement of the rigid flap while still providing a substantially weather-tight seal between the right flap and the pet door frame.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 illustrates a rigid pet door flap disposed in a frame and incorporating the gasket assembly of the present invention;

FIG. 2 illustrates a sectional view, taken generally at 2-2 of FIG. 1, of the gasket assembly of the present invention, minus the frame for clarity;

FIG. 3 illustrates a prior-art pet door incorporating the closest known pet door weather stripping configuration.

### DETAILED DESCRIPTION OF THE INVENTION

A pet door gasket assembly adapted to withstand continual operation and changing environmental conditions is shown in the figures and described herein. The general construction of a pet door is well known to those skilled in the art and, therefore, are not described in detail herein. Specifically, frames, flaps, closure mechanisms, locking mechanisms, and other common features are deemed to be within the purview of one of ordinary skill in the art. The pet door gasket assembly described herein is configured to allow a gasket to remain securely bonded to a pet door over time and in the presence of varying environment conditions. It will be understood by those skilled in the art that the pet door gasket assembly described herein can be used in various pet doors without departing from the scope and spirit of the present invention.

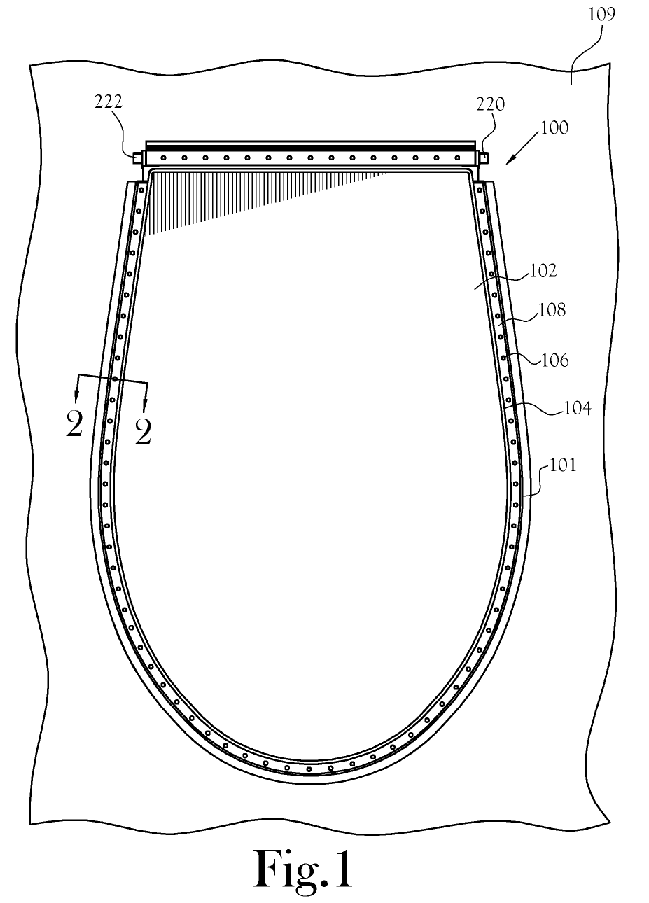

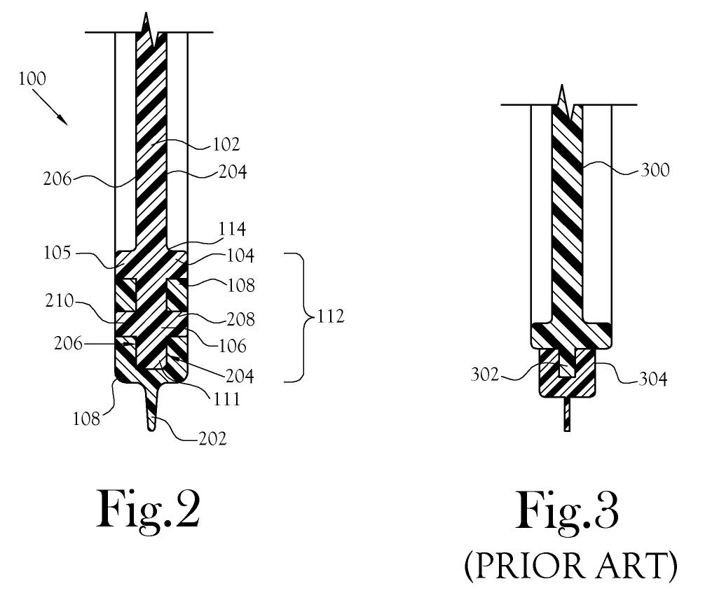

FIG. 1 illustrates a rigid flap 100 for use in a pet door incorporating the gasket assembly of the present invention. The depicted flap 100 includes a planar rigid central portion 102 having first and second opposite flat substantially planar faces 204, 206 that extend radially outwardly of the flap 100 to terminate in an annular perimetrical portion 112. At the junction 114 of the central portion 102 and the annual perimetrical portion 112 of the flap 100, there are provided a first flange member 104, which projects substantially perpendicularly away from the first face 204 of the flap 100, and a second flange member 105, which projects substantially perpendicularly away from the second face 206 of the flap 100. The central portion 102 and the flanges 104, 105 are fabricated from a substantially rigid material. The flap 100 is shaped to fit within a conventional opening (which is covered and, therefore, not visible in FIG. 1 or 2) in a pet door frame 109. In the illustrated embodiment, the flap 100 includes a first pivot pin 220 and a second pivot pin 222 adapted to pivotally engage the frame 109 and provide for pivotal mounting of the flap 100 within the ingress and egress opening in the frame 109. Further, in the illustrated embodiment of FIGS. 1 and 2, the flap 100 includes a flat annular perimetrical portion 112 of the rigid central portion 102. The annular perimetrical portion 112 extends laterally outward of the rigid central portion 102 to terminate in a perimetrical edge 111. A plurality of pins 106 are provided in a spaced-apart relationship along at least the length of the annular perimetrical portion 112. Each of the plurality of pins 106 extends through the thickness of the annular perimetrical portion 112 and has respective opposite end portions 208, 210 projecting from respective ones of the first opposing face 204 and the second opposing face 206 of the annular perimetrical portion 112. The pins 106 are also fabricated from a substantially rigid material. In the embodiment illustrated in FIGS. 1 and 2, a gasket 108 formed of a moldable, resilient, and flexible polymeric material encircles the perimetrical edge 111 of the flap 100 and extends radially inwardly and along the first and second faces 204, 206 of the annular perimetrical portion 112 of the central portion of the flap 100 about those end portions 208, 210 of the plurality of pins 106 that project from the faces of the annular perimetrical portion 112 of the flap. The gasket 108 terminates at the flanges 104, 105. This arrangement integrates the gasket 108 with the annular perimetrical portion 112 of the flap 100 and the plurality of pins 106 disposed on the opposing faces 204, 206 of the annular perimetrical portion 112 with one another and further with the central portion 102 of the flap 100 at the junction 114, thereby effectively unitizing the gasket 108 with the annular perimetrical portion 112 of the flap 100, and further to the central portion 102 of the flap 100. The unitizing comprises chemical, thermal, and mechanical affixation of the gasket 108 to the flap 100. More specifically, in the embodiment depicted in FIGS. 1 and 2, the gasket 108 continuously encircles the perimetrical edge 111 of the flap 100 along at least a major portion, and preferably all, of the length of the perimetrical edge 111 and extends continuously from the perimetrical edge 111 inwardly of the perimetrical edge 111 and along each of the opposite faces 204, 206 of the annual perimetrical portion 112 of the flap 100 and enveloping the exposed end portions 208, 210 of the plurality of pins 106 that project from respective ones of the opposite faces 204, 206, the gasket 108 being integral with said flap 100 inwardly beyond the first and second flanges 104, 105.

FIG. 2 illustrates a cross-section of the flap 100 taken through the gasket 108 and the annular perimetrical portion 112 of the flap 100 including one of the pins 106. As noted hereinbefore, the rigid flap 100 has two opposing faces 204, 206 and a central portion 102 that lies within the inward perimetrical boundary defined by the flanges 104, 105. In the depicted embodiment, an edge extension 202 of the gasket 108 lies laterally outside of and extends along at least a major portion of the perimetrical edge 212 of the gasket 108. An end portion 208, 210 of each pin projects from each face 204, 206 of the rigid annual perimetrical portion 112 of the flap 100 at respective spaced apart locations along at least a major portion of the length of the annular perimetrical portion 112. In the illustrated embodiment, the end portions 208, 210 are depicted as being axially aligned perpendicular to the plane of the annular perimetrical portion 112 of the flap 100 with their respective end portions 208, 210 projecting from respective ones of the first and second faces 204, 206 of the annular perimetrical portion of the flap 100. In the illustrated embodiment, the opposing pins 208, 210 are axially aligned; however, one skilled in the art will recognize that the opposing pins can be offset from one another without departing from the scope and spirit of the present invention. The pins shown in FIGS. 1 and 2 are illustrated as cylindrical posts; however, those skilled in the art will recognize that other geometries for the pins can be used without departing from the scope and spirit of the present invention.

In one embodiment, the gasket 108 is over-molded around the extended edge 202 and the pins 208, 210, generally occupying the area outside of the raised lip and forming wiping edge 212, which cooperates with the pet door frame to form a substantially weather-tight seal. The over-molding process provides both a chemical and thermal bond between the gasket 108 and the rigid member 102. The inclusion of the pins 208, 210 adds the enhancement of a mechanical bond between the gasket 108 and the rigid member 102.

The gasket 108 is fabricated from a flexible and resilient material. While there are several polymeric materials that are suitable for the construction of the gasket 108, the utilization of a thermoplastic elastomer (TPE) compounded with a permanent lubricant reduces friction between the gasket 108 and the pet door frame. Further, a gasket 108 fabricated from a lubricated polymeric material has increased resistance to wear and tearing. Alternatively, a thermoplastic vinyl (TPV) material can be used to construct the gasket without departing from the scope and spirit of the present invention.

A pet door gasket assembly adapted to provide a strong thermal, chemical, and mechanical bond between the gasket and the pet door flap has been shown and described. The gasket assembly incorporates a flexible, resilient, and permanently lubricated polymeric material chemically and thermally bonded to a rigid pet door flap. Further, the gasket is molded around series of pins extending from the faces of the rigid flap to provide a mechanical bond with the pet door flap. The lubricated gasket material resists wear and tear and offers reduced friction to allow for unhindered movement of the rigid flap while still providing a substantially weather-tight seal between the right flap and the pet door frame.

While the present invention has been illustrated by description of several embodiments and while the illustrative embodiments have been described in detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicants general inventive concept.

Having thus described the aforementioned invention, what is claimed is:

1. A pet door flap comprising:
a flap having a pair of opposing faces and a perimetrical edge;
a plurality of pins integrally formed with said flap member and extending from at least one of said pair of opposing faces, said plurality of pins spaced apart from each other along a substantial portion of said perimetrical edge of said flap; and
a gasket carried by said flap, said gasket disposed about a substantial portion said of said perimetrical edge of said flap, said gasket attached to at least one said one of said pair of opposing faces of said flap having said plurality of pins extending therefrom, said gasket surrounding said each of said plurality of pins.

2. The pet door flap of claim 1 wherein said gasket is overmolded onto said flap and around said plurality of pins.

3. The pet door flap of claim 1 wherein said gasket is fabricated from a polymeric material which is both flexible and resilient.

4. The pet door flap of claim 1 wherein said gasket is continuous along said substantial portion of said perimetrical edge to which said gasket is attached.

5. The pet door of claim 1 wherein said gasket is bonded to said flap by a chemical, thermal, or adhesive bond.

6. The pet door of claim 1 wherein said flap and said plurality of pins are fabricated from a substantially rigid material.

7. The pet door of claim 1 wherein said plurality of pins extend from each of said pair of opposing faces and said gasket is attached to each of said pair of opposing faces.

8. The pet door of claim 1 further comprising a flange integrally formed with said flap and extending from at least one of said opposing faces of said flap, said flange located inward of said plurality of pins and following a substantial portion of said perimetrical edge of said flap, said gasket attached to said flap outward of said flange.

9. A pet door flap comprising:
a flap having a pair of opposing faces and a perimetrical edge, said flap fabricated from a substantially rigid material;
a plurality of pins integrally molded as part of said flap member and extending at least one of said pair of opposing faces, said plurality of pins spaced apart from each other along a substantial portion of said perimetrical edge of said flap, said plurality of pins fabricated from a substantially rigid material; and
a gasket bonded onto a substantial portion said of said perimetrical edge around said each of said plurality of pins, said gasket being continuous and fabricated from a polymeric material which is both flexible and resilient.

10. The pet door of claim 9 further comprising a flange integrally formed with said flap and extending from at least one of said opposing faces of said flap, said flange located inward of said plurality of pins and following a substantial portion of said perimetrical edge of said flap, said gasket attached to said flap outward of said flange.

11. The pet door of claim 9 further comprising a flange integrally formed with said flap and extending from at least one of said opposing faces of said flap, said flange located inward of said plurality of pins and following a substantial portion of said perimetrical edge of said flap, said gasket attached to said flap outward of said flange.

12. The pet door of claim 9 wherein said flap and said plurality of pins are fabricated from a polymeric material.

13. A pet door comprising:
a frame defining an opening therethrough and adapted to pivotally mount said flap in position allowing ingress and egress of a pet through said opening;
a flap formed of a rigid material and adapted to be mounted within said opening of said frame for temporary displacement by the pet during ingress or egress through said opening, said flap having a pair of opposing faces and an annular perimetrical portion including a perimetrical edge;
a plurality of pins formed of a rigid material, said plurality of pins integrally formed with and extending from said flap at spaced apart locations along said annular perimetrical portion of said flap and inwardly of said perimetrical edge and having end portions projecting outwardly from respective ones of said pair of opposing faces of said flap;
a gasket disposed about a substantial portion of said annular perimetrical portion of said flap, said gasket attached at least one of said pair of opposing faces of said annular perimetrical portion of said flap inwardly of said perimetrical edge and enveloping said plurality of pins, said gasket fabricated from a polymeric material which is both flexible and resilient.

14. The pet door of claim 13 wherein said gasket is fabricated from a polymeric material which is permanently lubricated.

15. The pet door of claim 13 wherein said gasket is bonded to said flap by a chemical, thermal, or adhesive bond.

16. The pet door flap of claim 13 wherein said gasket is overmolded onto said flap and around said plurality of pins.

17. The pet door of claim 13 wherein said gasket continuously encircles said perimetrical edge of said flap along a substantial portion of said perimetrical edge.
